(19) United States
(12) Patent Application Publication
(10) Pub. No.: US 2026/0252594 A1
(43) Pub. Date: Aug. 27, 2026

(54) COMPUTING SYSTEM FOR MANAGING A MEMORY SYSTEM OF A GENERATIVE MODEL

(71) Applicant: Microsoft Technology Licensing, LLC, Redmond, WA (US)

(72) Inventors: Brian Scott KRABACH, Snohomish, WA (US); Michael Jameel JABBOUR, Forest Hills, NY (US); Marc A GOODNER, Kirkland, WA (US); Samuel Edward SCHILLACE, Portola Valley, CA (US)

(73) Assignee: Microsoft Technology Licensing, LLC, Redmond, WA (US)

(21) Appl. No.: 19/211,033

(22) Filed: May 16, 2025

Related U.S. Application Data
(60) Provisional application No. 63/762,536, filed on Feb. 24, 2025.

(51) Int. Cl. G06F 12/02

(52) U.S. Cl. CPC G06F 16/3329; G06F 16/245; G06F 16/3344

(57) ABSTRACT

A computing system implements an interaction interface, a client, and the memory system comprising short-term memory, working memory, and long-term memory. The client is configured to receive a request including a message having natural language input from the interaction interface, compile the message into a contextual bundle, input the contextual bundle into the generative model to generate a response, and output the response. The message is appended to the short-term memory, the short-term memory is aggregated into the working memory, and the working memory is stored into the long-term memory based on predetermined criteria. The contextual bundle is compiled to include one or more relevant entries of the long-term memory.

### CROSS REFERENCE TO RELATED APPLICATIONS

This application claims priority to U.S. Provisional Patent Application Ser. No. 63/762,536, filed Feb. 24, 2025, the entirety of which is hereby incorporated herein by reference for all purposes.

### BACKGROUND

The advent of generative models, especially large language models, has significantly advanced human-computer interactions. These models are trained on extensive data sets that enable them to generate text which can be coherent and contextually relevant. At inference time, their pretraining enables these models to produce human-like text that answers user queries in a logical manner, sometimes with citations to grounded (i.e., trusted) sources of data. Users often interact with these generative models through various platforms, for example by inputting inquiries, asking questions, or seeking advice on a wide range of topics. Such interactions can span simple queries like asking for a weather forecast to complex discussions about philosophy, technology, and beyond.

However, even state-of-the-art generative models face significant limitations: they often struggle to preserve extended contextual information over long interactions, dynamically incorporate new domain-specific knowledge, and self-monitor for errors or inconsistencies. Such challenges are especially problematic in high-stakes applications (e.g., legal analysis, medical diagnostics, and scientific research) where even minor lapses can have dire consequences. Thus, a challenge that persists in the realm of such generative models is that they are limited in their ability to handle extended context retention and dynamic knowledge updating.

### SUMMARY

To address the above issues, a computing system for managing a memory system of a generative model is provided. According to one aspect, the computing system includes processing circuitry and associated memory configured to implement an interaction interface, a client, and the memory system comprising short-term memory, working memory, and long-term memory. The client is configured to receive a request including a message having natural language input from the interaction interface, compile the message into a contextual bundle, input the contextual bundle into the generative model to generate a response, and output the response. The message is appended to the short-term memory, the short-term memory is aggregated into the working memory, and the working memory is stored into the long-term memory based on predetermined criteria. The contextual bundle is compiled to include one or more relevant entries of the long-term memory.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system according to an example implementation.

FIG. 2 is a schematic view showing an example use scenario of the computing system of FIG. 1.

FIG. 3 shows a flowchart of a first method for managing a memory system of a generative model according to one example implementation.

FIG. 4 shows a flowchart of a second method for updating weights of a generative model based on user feedback according to one example implementation.

FIG. 5 shows a schematic view of an example computing environment in which the computing system of FIG. 1 may be enacted.

### DETAILED DESCRIPTION

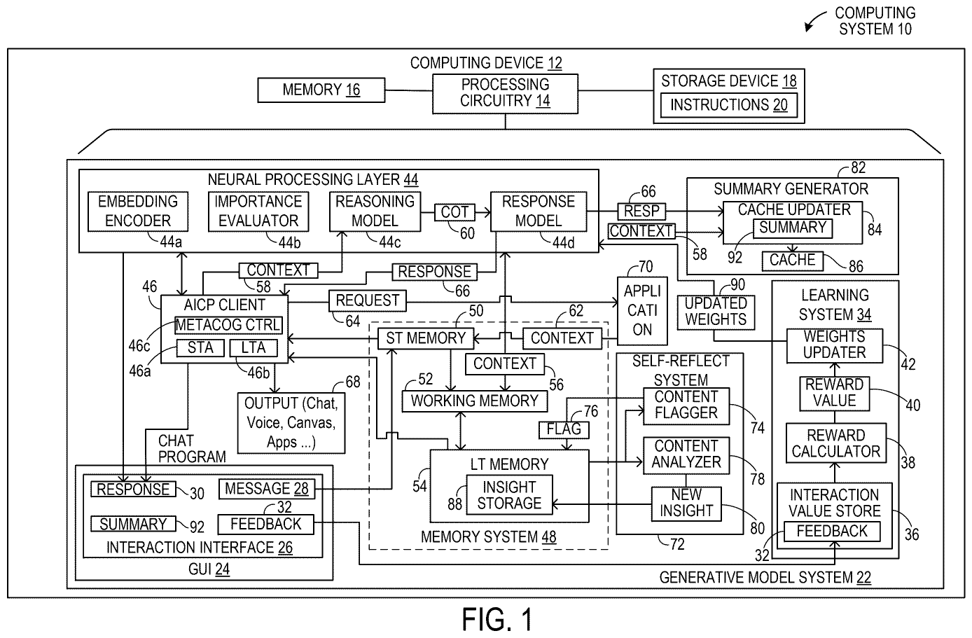

To address the various issues described above, FIG. 1 illustrates a schematic view of a computing system 10 for managing a memory system 48 of a generative model, according to an example implementation. The computing system 10 includes a computing device 12 having processing circuitry 14, memory 16, and a storage device 18 storing instructions 20. In this example implementation, the computing system 10 takes the form of a single computing device 12 storing instructions 20 in the storage device 18, including a generative model program 22 that is executable by the processing circuitry 14 to perform various functions including implementing the memory system 48, causing an interaction interface 26 for a trained generative models 44a-d of a neural processing layer 44 to be presented, and receiving, via the interaction interface 26, a message 28 from the user.

The neural processing layer 44 includes an embedding encoder 44a, an importance evaluator 44b, a reasoning model 44c, and a response model 44d. It will be understood that the trained generative models 44a-d encompass a broad range of generative models, including multi-modal models, diffusion models, and generative adversarial networks, which may receive text, image, and/or audio inputs and generate text, image, and/or audio outputs, as discussed in further detail below.

Each of the trained generative models 44a-d is a generative model that has been configured through machine learning to receive input that includes natural language text and generate output that includes natural language text in response to the input. It will be appreciated that the trained generative model 44a-d can be a large language model (LLM) having tens of millions to billions of parameters, non-limiting examples of which include Phi-4, GPT-4 and LLaMa-4. The trained generative language model 44a-d can be a multi-modal generative model configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Phi-4 visual, Kosmos-2 and GPT-4 VISUAL. Further, the trained generative language model 44a-d can be configured to have a generative pre-trained transformer architecture, examples of which are used in the GPT-4 model. Additionally, the trained generative language model can be a reasoning model such as o1, o1-mini, o3, or o3-mini. Finally, the trained generative language model can be a system of models, and include an orchestrator that selects an appropriate generative language model from among a set of available generative language models to process a current query or portion of a query. The set of available generative language models may include monomodal models, multi-modal models, and/or reasoning models, some of which may be co-called large models and others of which may be so-called small models, thereby availing a variety of functionalities and processing budgets to the orchestrator for servicing the query.

The memory system 48 comprises a short-term memory 50, working memory 52, and long-term memory 54. The short-term memory 50 is a bounded queue that stores the most recent messages along with metadata (e.g., unique identifiers, roles, and timestamps). The short-term memory 50 provides a temporary buffer that not only caches incoming data but also performs initial processing (e.g., formatting or tokenization) before further analysis. The working memory 52 consolidates entries of the short-term memory 50 into a coherent representation. The working memory 52 provides both a textual summary and learned embeddings, serving as a local workspace or active simulation buffer for multi-turn reasoning, iterative clarifications, and incremental context tracking. The long-term memory 54 is a repository for important knowledge that is stored in the long term. Entries may be selectively promoted from working memory 52 to the long-term memory 54 based on computed importance scores, usage frequencies, or explicit user instructions. Thus, the working memory 52 is configured as an orchestration layer to orchestrate the migration of memories with reinforcement.

Importance scores may be determined by an importance evaluator 44b based on the novelty of the memory entry, a user priority of the memory entry, and a retrieval volume of the memory entry. Importance scores may not just reflect the statistical prominence of memory entries, but also quantitatively reflect relevant and utility to system goals. For example, for each memory entry, a polygonal model formed by multiple query embeddings may be generated to define a high-dimensional volume functioning as a proxy for distributed salience. When the importance evaluator 44b determines that the polygon is larger than a predetermined size threshold or more stable than a predetermined stability threshold, the importance evaluator 44b may determine that the memory entry corresponding to the memory entry has sufficient contextual relevance across a plurality of prompts to selectively promote from working memory 52 to the long-term memory 54.

Additionally or alternatively, the importance evaluator 44b may update a weighting logic of a weights updater 42 for the generative models 44c, 44d and/or an interpretation logic of a content analyzer 78 based on salience signals of the polygonal model, so that the importance scores drive changes to the way the generative models 44c, 44d are updated and the way insights 80 are generated by the content analyzer 78.

The short-term memory 50, the working memory 52, and the long-term memory 54 may be organized as graph structures, or networks of nodes and edges, where each node represents an individual piece of knowledge (an entity, a fact, or a concept) and edges capture the relationships among them. These graph structures may allow the memory system 48 to emulate the neural replay pathways of the human brain. In neural replay, frequently activated paths are traversed, thereby reinforcing important connections. Infrequently accessed nodes or edges may be pruned to prevent memory overload.

The short-term memory 50, the working memory 52, and the long-term memory 54 may employ a dedicated sub-model for independent memory storage and retrieval. In a process that roughly emulates the hippocampal replay pathways in the human brain, the sub-model may be updated incrementally, thereby facilitating specialized parameter updates that may capture long-term dependencies.

The short-term memory 50, the working memory 52, and/or the long-term memory 54 may be organized into domain-specific modules, each acting as a special repository for knowledge pertinent to a particular field such as medicine, law, finance, or engineering. A gating mechanism within the memory system 48 may store and retrieve relevant memories from appropriate domain-specific modules. The gating mechanism may assess query confidence, domain overlap historical usage patterns in storing and retrieving memories in the short-term memory 50, the working memory 52, and/or the long-term memory 54, thereby minimizing cross-domain interference.

The short-term memory 50, the working memory 52, and the long-term memory 54 may be embedded directly into a transformer architecture by being incorporated inside a self-attention mechanism as a key-value store, thereby enabling seamless retrieval of stored context. By integrating the short-term memory 50, the working memory 52, and the long-term memory 54 into the attention layers of the transformer architecture, pipeline complexity may be reduced. Retrieval and generation may occur in a single forward pass, and updates to the memory store can be made with minimal disruption. Consequently, the overhead of separate retrieval calls and gating logic may diminish, thereby yielding faster inferences.

Key-value memory slots may be maintained at each attention layer, thereby allowing the memory system 48 to attend over previously stored information as new tokens are processed. Dynamic updates may be supported via insertion or deletion of memory entries at the attention layer level, thereby circumventing a full model retraining cycle. This may be particularly useful for domains with rapidly changing, real-time data. This integrated approach may also lend itself to more continuous forms of consolidation, wherein the memory slots are refreshed or pruned based on usage statistics or external feedback.

The generative model program 22 also includes an Artificial Intelligence Context Protocol (AICP) client 46 which generates a request 64 based on the message 28. The AICP client 46 sends the request 64 to at least one application 70. Responsive to receiving the request 64, the at least one application 70 generates and outputs contextual information 62, which is appended to the short-term memory 50 by the memory system 48 and forwarded to the AICP client 46. The AICP client 46 generates output 68 in accordance with the contextual information 62. The output 68 of the AICP client 46 is not particularly limited, and may encompass one or more modalities. For example, the output 68 may include outputting a response 30 on a voice interface, chat interface, and/or a canvas, for example. The output 68 is configured in accordance with AICP so that the AICP client 46 may easily interface with the one or more applications 70 that have also implemented AICP.

An AICP is an application layer protocol in the open services interconnection (OSI) model of client server communications that facilitates interaction between artificial intelligence (AI) models, as clients, and external services, as servers. An AICP endpoint refers to a server program operating at a network address that is configured with an application programming interface (API) for the external service, which operates according to the AICP protocol. The external service is thus a hosted application at the endpoint. The service is external to the model or model agent, but may be hosted locally on the same computing device or remotely on a server, for example.

One example AICP is the Model Context Protocol (MCP), which standardizes how AI models interact with external data sources, tools, and services, which are also characterized as AICP endpoints (or, MCP endpoints). AICP protocols such as MCP aim to provide a framework for the exchange of a model context with other application services, thereby enhancing the functionality of the model.

In some instances, the interaction interface 26 may be a portion of a GUI 24 for accepting user input and presenting information to a user. In other instances, the interaction interface 26 may be presented in non-visual formats such as an audio interface for receiving and/or outputting audio, such as may be used with a digital assistant. In yet another example the interaction interface 26 may be implemented as an interaction interface API. In such a configuration, the input to the interaction interface 26 may be made by an API call from a calling software program to the interaction interface API, and output may be returned in an API response from the interaction interface API to the calling software program. The API may be a local API or a remote API accessible via a computer network such as the Internet.

It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. Thus, the processing circuitry 14 may be configured to execute the interaction interface API (for example, interaction interface 26) for the trained generative models 44a-d, so that the processing circuitry 14 is configured to interface with the trained generative models 44a-d that receives input of contextual information 56 and, in response, generates a response 30 that includes natural language text output. Likewise, communications between the AICP client 46 and the one or more applications 70 and the trained generative models 44a-d can be implemented using local or remote APIs.

In general, the processing circuitry 14 may be configured to receive, via the interaction interface 26 (in some implementations, the interaction interface API), the message 28 as natural language text input. The memory system 48 subsequently appends the message 28 to short-term memory 50, which may hold immediate recent interactions between the user and the generative model program 22. For example, the short-term memory 50 may hold a predetermined number of messages (ten messages, for example). The short-term memory 50 provides context for current and recent exchanges between the user and the generative model program 22, and aids in resolving references and understanding user intent. Each entry in the short-term memory 50 may include a unique identifier, role metadata, and a timestamp.

The memory system 48 concatenates or aggregates the short-term memory 50 into working memory 52, and encodes the working memory 52 into embeddings via the embedding encoder 44a. The working memory 52 acts as an intermediary, synthesizing information from the short-term memory 50 to form a cohesive context. Through the exchange of contextual information 56, the memory system 48 queries the importance evaluator 44b of the neural processing layer 44 to assign an importance score to the encoded working memory 52. When the importance score returned by the importance evaluator 44b exceeds a predetermined score threshold, then the memory system 48 appends the working memory 52 to long-term memory 54.

The long-term memory 54 may store significant information, insights, and important tasks over extended periods, providing historical context for interactions, supporting advanced querying, and implementing mechanisms to reduce hallucinations by grounding information in actual user interactions. The operations of the memory system 48 may be performed continuously in real-time, so that the memory system 48 continuously incorporates new data into short-term memory 50, aggregates the short-term memory 50 into working memory 52, and then stores the high importance working memory 52 into the long-term memory 54.

The long-term memory 54 may employ mechanisms for selective forgetting via exponential decay, thereby ensuring that low-value or outdated information is pruned. For example, to manage the size and relevance of the long-term memory 54, each entry of the long-term memory 54 may be assigned a weight that decays exponentially over time: w(t)=w₀exp(−λt)×a×p×u, where w₀ is the initial weight, λ is the decay rate, a is the access frequency of the entry, p is the contradiction penalty for the entry, and f is a feedback signal. Reinforcement signals, such as user feedback or repeated access, may add a positive offset to the weight to counteract decay. For example, when a given entry of the long-term memory 54 is accessed or receives positive feedback, then the weight of the given entry may be increased by a product of a reward constant and a reward value. When a contradiction is detected in the entry, the weight of the given entry may be decreased by the contradiction penalty.

The operations of appending memories to the short-term memory 50, the working memory 52, and the long-term memory 54 may not be limited to a simple logging operation. In some examples the operations of appending memories may include complex memory management operations such as rewriting prior memory entries, reframing existing contextual associations, and reindexing memory contents in accordance with new outcomes or updated interpretations of prior data. For example, the memory system 48 may modify earlier memory entries to reflect corrected inferences, reinterpret prior interactions in light of updated contextual information, or update the indexing structure of the memories 50, 52, 54, thereby enhancing contextual continuity. It will be appreciated that the rewriting of prior memory entries and the reframing of existing contextual associations may include not only the modification of exiting memory entries, but also extensive reconstructions of a plurality of memory entries which may include the consolidation of memory entries, the deletion of redundant memory entries, and the partitioning and reconsolidation of memory entries, thereby increasing the coherence of the memory system 48.

The AICP client 46 receives the short-term memory 50 with the appended message 28 and parse the message 28 to generate a request 64. Using the neural processing layer 44, the AICP client 46 may identify short-term actions 46a and/or long-term actions 46b based on the message 28, and incorporate these short-term actions 46a and/or long-term actions 46b in the request 64 to be sent to the one or more applications 70. The request 64 may be formatted and sent in accordance with AICP.

Short-term actions 46a are immediate tasks requiring prompt execution, often based on recent interactions. Examples of short-term actions 46a include sending an e-mail or scheduling a meeting. Repeated short-term actions 46a may be converted into automated routines in the long-term actions 46b. Long-term actions 46b are tasks that are part of ongoing projects or require extended time to complete. Examples of long-term actions 46b include developing a marketing strategy or compiling a comprehensive report. The AICP client 46 may cause one or more applications 70 to execute the short-term actions 46a and/or long-term actions 46b. The applications 70 which execute the long-term actions 46b may be AI agents for tasks suitable for automation, including data analysis, for example.

The AICP client 46 may encode the message 28 into embeddings using the embedding encoder 44a, and then retrieve one or more entries of long-term memory 54 that are the most similar to the message 28 as relevant long-term memory 54. Similarity may be determined using a similarity metric or distance function. For example, an embeddings-based vector similarity search may be employed using databases such as Pinecone or Weaviate.

A top predetermined number of entries of the long-term memory 54 that score the highest in similarity to the message 28 may be selected as relevant long-term memory. The AICP client 46 may then compile the one or more relevant entries of the long-term memory 54, the short-term memory 50, working memory 52, identified short-term actions 46a, and identified long-term actions 46b into a contextual bundle 58, and input the contextual bundle 58 into the reasoning model 44c to generate a chain-of-thought response 60. The contextual bundle 58 may be sent to the reasoning model 44c in accordance with AICP. The chain-of-thought response 60 may be inputted into the response model 44d to generate a response 66 to execute the identified short-term actions 46a and/or long-term actions 46b. The response model 44d then sends the response 66 to the AICP client 46 in accordance with AICP.

The AICP client 46 may then make API calls to one or more applications 70 to execute the identified short-term actions 46a and/or long-term actions 46b in accordance with the response 66 generated by the response model 44d. Additionally or alternatively, the AICP client 46 may generate and output the response 66 as a natural language response 30 via the interaction interface 26. The execution of the short-term actions 46a and/or long-term actions 46b is illustrated as output 68 in FIG. 1.

The AICP client 46 may further execute a metacognitive control module 46c to compare the response 66 with the relevant entries of the long-term memory 54 and the working memory 52 to detect any mismatches or inconsistencies. The metacognitive control module 46c may function as a monitoring and verification module to monitor and verify the decision quality of the responses 66 and pause the generation of responses 66 by the response model 44d. The metacognitive control module 46c may also be configured to reroute, escalate, or defer responses 66 based on the verified decision quality of the responses 66. Responsive to detecting a mismatch or inconsistency, the AICP client 46 may input a prompt into the response model 44d to adjust the response 66. For example, the metacognitive control module 46c may obtain an output distribution (p) of the response 66, calculate a Shannon entropy H(p) of the output distribution (p), where

$$H ( p ) = - {\sum }_{i = 1}^{N} {p}_{i} log ( {p}_{i} ) ,$$

and normalize the entropy calculation to produce a confidence

$$score = 1 - \frac{H ( p )}{log N} .$$

The confidence score may also be calculated by determining whether ambiguous, contradictory, or inconsistent statements are included in the response 66. When the confidence score falls below a predetermined score threshold, the metacognitive control module 46c may retrieve additional context, invoke user-confirmation fallback modules, or request user clarification. In addition to invoking user-confirmation fallback modules, the metacognitive control module 46c may trigger abductive reinterpretation, generating alternate hypotheses or framings when inconsistencies emerge. The actions that the AICP client 46 takes in response to the confidence score may be governed by a policy model which governs response quality. Accordingly, factual correctness of the response 66 may be ensured.

The computing system 10 may further comprise a learning system which is configured to update weights of the response model 44d based on user feedback 32 received at the interaction interface 26. The learning system 34 comprises an interaction value store 36, reward calculator 38, and a weights updater 42. Responsive to receiving the user feedback 32 at the interaction interface 26, the user feedback 32 is appended to the interaction value store 36. For each feedback 32 in the interaction value store 36, the reward calculator 38 calculates a reward value 40. Based on the calculated reward value 40, the weights updater 42 calculates updated weights 90 for the reasoning model 44c and/or the response model 44d, and the weights updater 42 applies the updated weights 90 to the reasoning model 44c and/or the response model 44d. For example, the reward value 40 may be subtracted from the standard cross-entropy loss [symbol] ₜₒₜₐₗ= [symbol] _{CE}−βr, where [symbol] _{CE} is the standard cross-entropy loss, and β scales the impact of the reward value 40. The weights updater 42 may update the weights 90 of the reasoning model 44c and/or the response model 44d at predetermined scheduled times, during inference time, or in a continuous process.

The computing system 10 may further comprise a self-reflection system 72 configured to generate insights 80 and flag 76 entries of the long-term memory 54. The self-reflection system 72 may include a content flagger 74 configured to generate the content flags 76 and a content analyzer 78 configured to generate insights 80. The entries of the long-term memory 54 may be analyzed by the content analyzer 78 to identify patterns within the entries of the long-term memory 54. Responsive to determining that the identified patterns are significant, the entries of the long-term memory 54 containing the identified patterns are stored in an insight storage 88 within the long-term memory 54.

In one embodiment, the insights 80 generated by the content analyzer 78 may involve a schema change, which is a modification in the underlying structure by which a particular domain, context, and/or user goal is interpreted. Schema changes may include the introduction of new decision paths, memory categories, or reasoning modes, for example. The schema changes may update a weighting logic of the weights updater 42 and/or an interpretation logic of the content analyzer 78. Such schema changes may occur when the content analyzer 78 identifies patterns or trends in the long-term memory 54 that are inconsistent with prior assumptions or reveal new, more effective frameworks for understanding user behavior, environmental signals, or task structure. Upon determining that a schema change is warranted, the self-reflection system 72 may recursively update the interpretation logic of the content analyzer 78, thereby ensuring that subsequent entries of the long-term memory 54 which are inputted into the content analyzer 78 are interpreted differently, and different insights 80 are generated. This may allow the self-reflection system 72 to engage in adaptive learning over time, thereby improving its ability to anticipate user needs, respond to novel situations, and refine its behavior based on accumulated experience. The schema changes may be cataloged in the insight storage 88.

The entries of the working memory 52 or the long-term memory 54 may also be analyzed by the content flagger 74 to compare a given pair of entries in the working memory 52 or the long-term memory 54 to identify ambiguous, contradictory, or inconsistent statements. Responsive to determining that the given pair of entries contains ambiguous, contradictory, or inconsistent statements, the given pair of entries is flagged, and a content flag 76 is generated for subsequent review. The content flag 76 may be subsequently stored within the working memory 52 or the long-term memory 54.

The content flags 76 may be used to train the importance evaluator 44b, the reasoning model 44c, and/or the metacognitive control module 46c. For example, the content flags 76 may be used as training data to train the metacognitive control module 46c to detect any mismatches or inconsistencies. The training data may also be used to train the importance evaluator 44b to assign lower confidence scores to responses 66 with ambiguous, contradictory, or inconsistent statements. Memory entries in the working memory 52 with the content flags 76 may block the memory system 48 promoting the memory entries to the long-term memory 54.

The computing system 10 may further comprise a summary generator 82 for generating a summary 92 by merging newly recognized tasks, goals, decisions, and/or relevant ephemeral details contained in the contextual bundle 58 and the response 66. The summary generator 82 may include a cache updater 84 and a cache 86. The cache updater 84 may be configured as an ephemeral caching mechanism to prevent stale data accumulation. The cache 86 may be stored in fast in-memory databases for quick updates and access. For example, the in-memory database may be Redis.

The cache updater 84 identifies tasks, goals, decisions, and/or relevant ephemeral details within the contextual bundle 58 and the response 66 to generate the summary 92, which is subsequently stored in the cache 86. The summary 92 may be displayed on the interaction interface 26 for quick and easy accessibility by the user and/or inputted into the AICP client 46 to provide continuity and coherence in the interactions of the user with the computing system 10. The cache updater 84 may automatically prune the cache 86 to avoid confusion with older context. In one implementation, the cache updater 84 may gather short-term actions or user requests from a predetermined number of interactions, summarize the short-term actions or requests into a short paragraph, and then overwrite or partially update the cache 86.

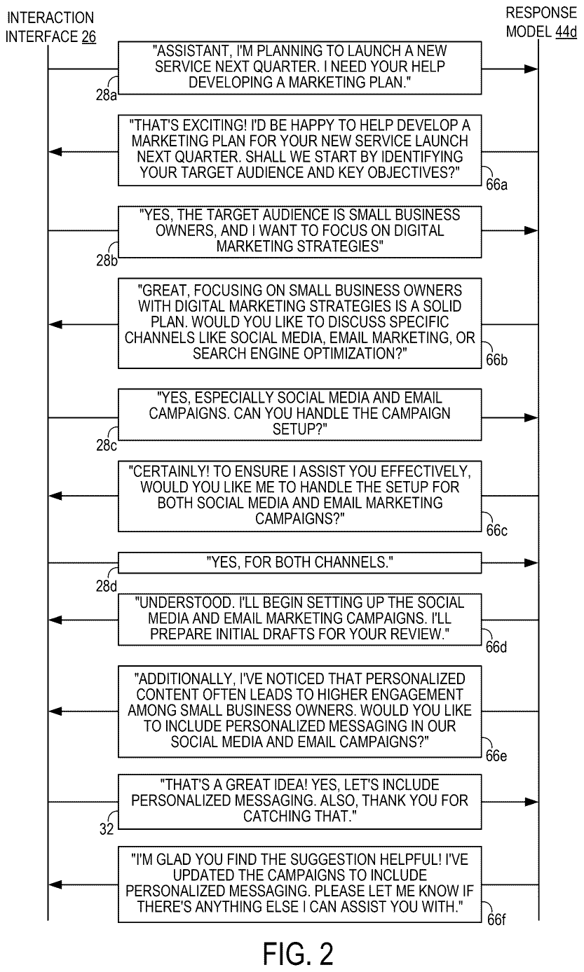

Turning now to FIG. 2, an example use of the generative model program of FIG. 1 is illustrated. In this example use scenario, a user uses the voice interaction interface 26 to input the message 28a, “Assistant, I'm planning to launch a new service next quarter. I need your help developing a marketing plan.”

The message 28a is appended to the short-term memory 50 and then aggregated into the working memory 52. The message 28a is assigned an importance score by the importance evaluator 44b. Responsive to determining that the importance score exceeds a predetermined score threshold, the message 28a is appended to the long-term memory 54. The short-term memory 50 including the appended message 28a is incorporated into a contextual bundle 58, which is processed by the summary generator 82 to generate a summary 92 indicating a task (“Develop a marketing plan”), a priority (“High”), and a context (“Target audience: Small business owners, Focus: Digital marketing”).

The AICP client 46 identifies a long-term action 46b with a description (“Develop a marketing plan for the new service launch next quarter”) and an assignment to an AI application 70. A contextual bundle 58 including the long-term action 46b is inputted into the reasoning model 44c to generate a chain-of-thought response 60. The chain-of-thought response 60 is inputted into the response model 44d to generate and output the response 66a, “That's exciting! I'd be happy to help develop a marketing plan for your new service launch next quarter. Shall we start by identifying your target audience and key objectives?”

The user responds to the response 66a by inputting the message 28b, “Yes, the target audience is small business owners, and I want to focus on digital marketing strategies”. The message 28b is appended to the short-term memory 50 and then aggregated into the working memory 52. The message 28b is assigned an importance score by the importance evaluator 44b. Responsive to determining that the importance score exceeds a predetermined score threshold, the message 28b is appended to the long-term memory 54. The short-term memory 50 including the appended message 28b is passed to the AICP client 46, which updates the long-term action 46b with the description (“Develop a marketing plan for the new service launch next quarter”) to include the metadata, “target audience=small business owners” and “focus areas=digital marketing strategies”.

The AICP client 46 generates a contextual bundle 58 including the updated long-term action 46b. The contextual bundle 58 is inputted into the reasoning model 44c to generate a chain-of-thought response 60. The chain-of-thought response 60 is inputted into the response model 44d to generate and output the response 66b, “Great, focusing on small business owners with digital marketing strategies is a solid plan. Would you like to discuss specific channels like social media, email marketing, or search engine optimization?” The response 66b is subsequently appended to the short-term memory 50.

The user responds with a message 28c, “Yes, especially social media and email campaigns. Can you handle the campaign setup?” The message 28c is appended to the short-term memory 50 and then aggregated into the working memory 52. The message 28c is assigned an importance score by the importance evaluator 44b. Responsive to determining that the importance score exceeds a predetermined score threshold, the message 28c is appended to the long-term memory 54.

The message 28c in the long-term memory 54 is inputted into the content flagger 74 of the self-reflection system 72 to detect any ambiguities, inconsistencies, or contradictions in the message 28c. The content flagger 74 identifies an ambiguity, as the user may be asking to handle the campaign setup for the social media campaign, the email campaign, or both. The content flagger 74 generates a content flag 76, which is appended to the long-term memory 54. The content flag 76 is retrieved by the AICP client 46 as a relevant long-term memory 54. The content flag 76 is incorporated into a contextual bundle 58 and inputted into the reasoning model 44c to generate a chain-of-thought response 60, which is inputted into the response model 44d.

To resolve the ambiguity, the response model 44d follows up by generating a response 66c including the question, “Certainly! To ensure I assist you effectively, would you like me to handle the setup for both social media and email marketing campaigns?” The response 66c is subsequently appended to the short-term memory 50.

The user responds with a message 28d clarifying, “Yes, for both channels.” The message 28d is appended to the short-term memory 50. The AICP client 46 updates the long-term action 46b with the description (“Develop a marketing plan for the new service launch next quarter”) to include the metadata, “channels=Social Media, Email Marketing”. The AICP client 46 also generates a short-term action 46a with the description (“Set up social media and email marketing campaigns”) and an assignment to an AI application 70. In response 66d, the response model 44d states, “Understood. I'll begin setting up the social media and email marketing campaigns. I'll prepare initial drafts for your review.” The response 66d is subsequently appended to the short-term memory 50.

In the meantime, the self-reflection system 72 analyzes the long-term memory 54 for new insights 80 or content flags 76. The content analyzer 78 filters the entries of the long-term memory 54 for mentions of “digital marketing strategies” and generates the insights 80, “personalized content may improve engagement with small business owners” and “recommend incorporating personalized messaging into campaigns”. These insights 80 are appended to the insight storage 88 of the long-term memory 54, which are then retrieved by the AICP client 46 as relevant long-term memory 54. The summary generator 82 may incorporate the insights 80 into a summary 92 which is displayed on the interaction interface 26, and the summary 92 may be inputted into the AICP client 46 so that the insights 80 form part of a subsequent round of synthesis of working memory 52.

The insights 80 are incorporated into the contextual bundle 58 which is inputted into the reasoning model 44c to generate a chain-of-thought response 60. The response model 44d, receives input of the chain-of-thought response 60 to generate a response 66e which prompts for user feedback, “Additionally, I've noticed that personalized content often leads to higher engagement among small business owners. Would you like to include personalized messaging in our social media and email campaigns?” The response 66e is subsequently appended to the short-term memory 50.

In response, the user gives feedback 32, “That's a great idea! Yes, let's include personalized messaging. Also, thank you for catching that.” The feedback 32 is also appended to the short-term memory 50 and also appended to the interaction value store 36 in the learning system 34, a reward value 40 is calculated based on the user feedback 32, and the weights of the response model 44d are updated by the weights updater 42 based on the reward value 40. The response model 44d then generates a response 66f, “I'm glad you find the suggestion helpful! I've updated the campaigns to include personalized messaging. Please let me know if there's anything else I can assist you with.” The insights 80 incorporated into the response 66f may also be incorporated into the short-term memory 50 and the working memory 52 as the response 66f is directed into the memory system 48. The insights 80 may also be incorporated into the summary 92 displayed on the interaction interface 26 as the response 66f is inputted into the summary generator 82.

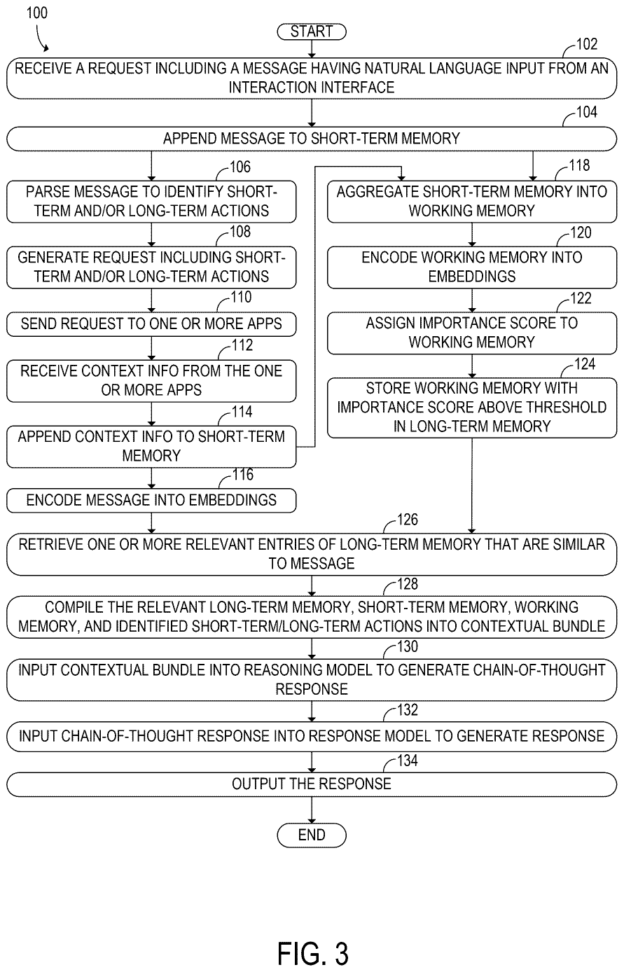

FIG. 3 is a flowchart that illustrates a first method 100 for managing a memory system of a generative model. The first method 100 may be implemented on the computing system 10 illustrated in FIG. 1 above, which include processing circuitry and associated memory configured to implement an interaction interface, an AICP client, a memory system, and a neural processing layer. Alternatively, other suitable computing hardware and software may be utilized.

At 102, the method includes receiving a request including a message having natural language input from the interaction interface. At 104, the method includes appending the message to short-term memory. At 106, the method includes parsing the message to identify short-term actions and/or long-term actions. At 108, the method includes generating a request including the short-term actions and/or the long-term actions. At 110, the method includes sending the request to one or more applications. At 112, the method includes receiving contextual information from the one or more applications. At 114, the method includes appending the contextual information to the short-term memory.

Subsequent to the data becoming appended to the short-term memory at steps 104 and 114, the appended data migrates into working memory and long-term memory at steps 118, 120, 122, and 124, which are performed continuously in real-time. At 118, the method includes aggregating the short-term memory into working memory. At 120, the method includes encoding the working memory into embeddings. At 122, the method includes assigning an importance score to the working memory. At 124, it is determined whether the importance score assigned to the working memory is above a predetermined score threshold. Responsive to determining that the importance score is above the predetermined score threshold, at 124, the working memory is stored in long-term memory.

At 116, the method includes encoding the message into embeddings. At step 126, the method includes retrieving one or more entries of long-term memory that are similar to the message as relevant long-term memory. Similarity may be determined using an embeddings-based vector similarity search. At 128, the method includes compiling the relevant long-term memory, short-term memory, working memory, and identified short-term actions and/or identified long-term actions into a contextual bundle. At 130, the method includes inputting the contextual bundle into a reasoning model to generate a chain-of-thought response. At step 132, the method includes inputting the chain-of-thought response into a response model to generate a response. At 134, the method includes outputting the response.

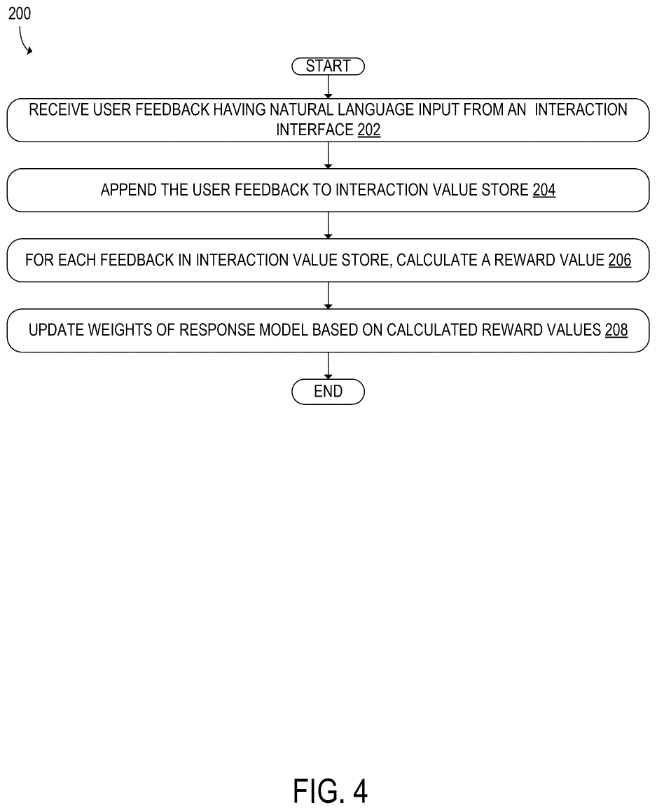

FIG. 4 is a flowchart that illustrates a second method 200 for updating weights of a generative model based on user feedback. The second method 200 may be implemented on the computing system 10 illustrated in FIG. 1 above, which include processing circuitry and associated memory configured to implement an interaction interface, an AICP client, a memory system, and a neural processing layer. Alternatively, other suitable computing hardware and software may be utilized.

At 202, the method includes receiving user feedback having natural language input from the interaction interface. At 204, the method includes appending the user feedback to an interaction value store. At 206, the method includes, for each feedback in the interaction value store, calculating a reward value. At 208, the method includes updating weights of a response model based on the calculated reward values.

The above-described system and methods augment large language models with memory systems inspired by human cognitive neuroscience, integrating mechanisms for dynamic encoding and metacognitive error monitoring, thereby adding human-like adaptability, resilience, and self-monitoring to generative model programs. The memory system distinguishes among short-term, working, and long-term memory, mirroring human cognitive processes. The short-term memory serves as a bounded buffer for recent inputs. The working memory aggregates and consolidates these inputs into a coherent representation, facilitating multi-turn reasoning and iterative clarifications. Long-term memory retains important information that is selectively promoted from working memory based on important heuristics and reinforced through user feedback and reward-modulated updates. This hierarchical arrangement enables the memory system to continuously learn, adapt, and self-correct in real time. Accordingly, context retention, adaptive knowledge updates, and metacognitive control may be enhanced in generative model programs.

In some embodiments, the methods and processes described herein may be tied to a computing system of one or more computing devices. In particular, such methods and processes may be implemented as a computer-application program or service, an application-programming interface (API), a library, and/or other computer-program product.

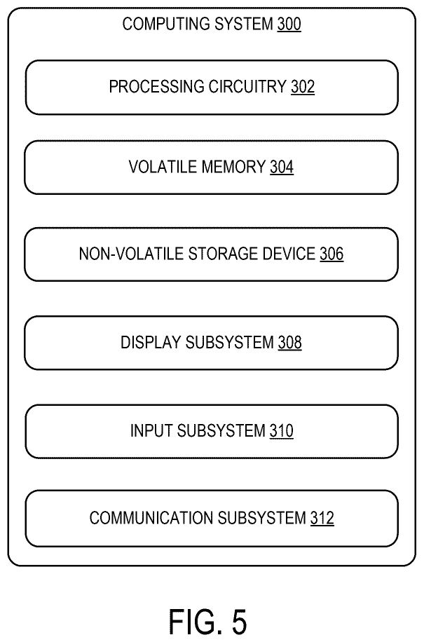

FIG. 5 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (for example, smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 5.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of aspects of the present disclosure. In one aspect, a computing system for managing a memory system of a generative model is provided, the system comprising processing circuitry and associated memory configured to implement an interaction interface, the memory system comprising short-term memory, working memory, and long-term memory, and a client configured to receive a request including a message having natural language input from the interaction interface, compile the message into a contextual bundle, input the contextual bundle into the generative model to generate a response, and output the response, wherein the message is appended to the short-term memory, the short-term memory is aggregated into working memory, the working memory is stored into the long-term memory based on predetermined criteria, and the contextual bundle is compiled to include one or more relevant entries of the long-term memory. In this aspect, additionally or alternatively, the working memory may be encoded into embeddings, the encoded working memory may be assigned an importance score, and the predetermined criteria may include the importance score exceeding a predetermined score threshold. In this aspect, additionally or alternatively, the one or more relevant entry of the long-term memory may be determined to be similar to the message based on an embeddings-based vector similarity search. In this aspect, additionally or alternatively, the generative model may be a response model, the contextual bundle may be inputted into a reasoning model to generate a chain-of-thought response, the chain-of-thought response may be inputted into the response model to generate the response. In this aspect, additionally or alternatively, the system may further comprise a learning system comprising an interaction value store configured to append user feedback received at the interaction interface, a rewards calculator configured to calculate a reward value based on the user feedback, and a weights updater configured to update weights of the generative model based on the reward value. In this aspect, additionally or alternatively, the weights of the generative model may be updated by subtracting the reward value from a standard cross-entropy loss [symbol] ₜₒₜₐₗ= [symbol] _{CE}−βr, where [symbol] _{CE} is the standard cross-entropy loss, and β scales an impact of the reward value. In this aspect, additionally or alternatively, the system may further comprise a content analyzer configured to analyze entries of the long-term memory, identify patterns within the entries of the long-term memory, generate insights based on the identified patterns, and store the generated insights within the long-term memory. In this aspect, additionally or alternatively, the generation of insights may include updating a weighting logic of a weights updater configured to update weights of the generative model and/or update an interpretation logic of the content analyzer. In this aspect, additionally or alternatively, the system may further comprise a content flagger configured to analyze entries of the long-term memory, compare a given pair of entries in the long-term memory to identify ambiguous, contradictory, or inconsistent statements, responsive to determining that the given pair of entries contains ambiguous, contradictory, or inconsistent statements, generate a content flag, store the content flag within the long-term memory. In this aspect, additionally or alternatively, the system may further comprise a summary generator configured to merge the contextual bundle and the response to generate a summary, and display the summary on the interaction interface.

In another aspect, a computerized method for managing a memory method of a generative model is provided, the method comprising receiving a request including a message having natural language input from an interaction interface, compiling the message into a contextual bundle, inputting the contextual bundle into the generative model to generate a response, and outputting the response, wherein the message is appended to short-term memory, the short-term memory is aggregated into working memory, the working memory is stored into long-term memory based on predetermined criteria, and the contextual bundle is compiled to include one or more relevant entries of the long-term memory. In this aspect, additionally or alternatively, the working memory may be encoded into embeddings, the encoded working memory may be assigned an importance score, and the predetermined criteria may include the importance score exceeding a predetermined score threshold. In this aspect, additionally or alternatively, the one or more relevant entry of the long-term memory may be determined to be similar to the message based on an embeddings-based vector similarity search. In this aspect, additionally or alternatively, a top predetermined number of entries of the long-term memory that score highest in similarity to the message may be selected as the one or more relevant entries of the long-term memory. In this aspect, additionally or alternatively, the generative model may be a response model, the contextual bundle may be inputted into a reasoning model to generate a chain-of-thought response, the chain-of-thought response may be inputted into the response model to generate the response. In this aspect, additionally or alternatively, the computerized method may further comprise appending user feedback received at the interaction interface to an interaction value store, calculating a reward value based on the user feedback, and updating weights of the generative model based on the reward value. In this aspect, additionally or alternatively, the weights of the generative model may be updated by subtracting the reward value from a standard cross-entropy loss [symbol] ₜₒₜₐₗ= [symbol] _{CE}−βr, where [symbol] _{CE} is the standard cross-entropy loss, and β scales an impact of the reward value. In this aspect, additionally or alternatively, the computerized method may further comprise analyzing entries of the long-term memory, identifying patterns within the entries of the long-term memory, generating insights based on the identified patterns, and storing the generated insights within the long-term memory. In this aspect, additionally or alternatively, the computerized method may further comprise analyzing entries of the long-term memory, comparing a given pair of entries in the long-term memory to identify ambiguous, contradictory, or inconsistent statements, responsive to determining that the given pair of entries contains ambiguous, contradictory, or inconsistent statements, generating a content flag, storing the content flag within the long-term memory.

In another aspect, a computing system is provided comprising processing circuitry and associated memory configured to implement an interaction interface configured to receive a message having natural language input, a memory system comprising short-term memory, working memory, and long-term memory, wherein the processing circuitry is configured to append the message to the short-term memory, aggregate the short-term memory into the working memory, and store the working memory into the long-term memory based on predetermined criteria, retrieve one or more relevant entries of the long-term memory, generate a contextual bundle including the one or more relevant entries of the long-term memory, input the contextual bundle into a generative model to generate a response, and output the response.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for managing a memory system of a generative model, the system comprising:
processing circuitry and associated memory configured to implement:
an interaction interface;
the memory system comprising:
short-term memory,
working memory, and
long-term memory; and
a client configured to:
receive a request including a message having natural language input from the interaction interface;
compile the message into a contextual bundle;
input the contextual bundle into the generative model to generate a response; and
output the response, wherein
the message is appended to the short-term memory;
the short-term memory is aggregated into working memory;
the working memory is stored into the long-term memory based on predetermined criteria; and
the contextual bundle is compiled to include one or more relevant entries of the long-term memory.

2. The computing system of claim 1, wherein
the working memory is encoded into embeddings;
the encoded working memory is assigned an importance score; and
the predetermined criteria include the importance score exceeding a predetermined score threshold.

3. The computing system of claim 1, wherein the one or more relevant entry of the long-term memory is determined to be similar to the message based on an embeddings-based vector similarity search.

4. The computing system of claim 1, wherein
the generative model is a response model;
the contextual bundle is inputted into a reasoning model to generate a chain-of-thought response;
the chain-of-thought response is inputted into the response model to generate the response.

5. The computing system of claim 1, further comprising:
a learning system comprising:
an interaction value store configured to append user feedback received at the interaction interface;
a rewards calculator configured to calculate a reward value based on the user feedback; and
a weights updater configured to update weights of the generative model based on the reward value.

6. The computing system of claim 5, wherein the weights of the generative model are updated by subtracting the reward value from a standard cross-entropy loss [symbol] ₜₒₜₐₗ= [symbol] _{CE}−βr, where [symbol] _{CE} is the standard cross-entropy loss, and β scales an impact of the reward value.

7. The computing system of claim 1, further comprising a content analyzer configured to:
analyze entries of the long-term memory;
identify patterns within the entries of the long-term memory;
generate insights based on the identified patterns; and
store the generated insights within the long-term memory.

8. The computing system of claim 7, wherein the generation of insights includes updating a weighting logic of a weights updater configured to update weights of the generative model and/or update an interpretation logic of the content analyzer.

9. The computing system of claim 1, further comprising a content flagger configured to:
analyze entries of the long-term memory;
compare a given pair of entries in the long-term memory to identify ambiguous, contradictory, or inconsistent statements;
responsive to determining that the given pair of entries contains ambiguous, contradictory, or inconsistent statements, generate a content flag;
store the content flag within the long-term memory.

10. The computing system of claim 1, further comprising a summary generator configured to:
merge the contextual bundle and the response to generate a summary; and
display the summary on the interaction interface.

11. A computerized method for managing a memory method of a generative model, the method comprising:
receiving a request including a message having natural language input from an interaction interface;
compiling the message into a contextual bundle;
inputting the contextual bundle into the generative model to generate a response; and
outputting the response, wherein
the message is appended to short-term memory;
the short-term memory is aggregated into working memory;
the working memory is stored into long-term memory based on predetermined criteria; and
the contextual bundle is compiled to include one or more relevant entries of the long-term memory.

12. The computerized method of claim 11, wherein
the working memory is encoded into embeddings;
the encoded working memory is assigned an importance score; and
the predetermined criteria include the importance score exceeding a predetermined score threshold.

13. The computerized method of claim 11, wherein the one or more relevant entry of the long-term memory is determined to be similar to the message based on an embeddings-based vector similarity search.

14. The computerized method of claim 13, wherein a top predetermined number of entries of the long-term memory that score highest in similarity to the message are selected as the one or more relevant entries of the long-term memory.

15. The computerized method of claim 11, wherein
the generative model is a response model;
the contextual bundle is inputted into a reasoning model to generate a chain-of-thought response;
the chain-of-thought response is inputted into the response model to generate the response.

16. The computerized method of claim 11, further comprising:
appending user feedback received at the interaction interface to an interaction value store;
calculating a reward value based on the user feedback; and
updating weights of the generative model based on the reward value.

17. The computerized method of claim 16, wherein the weights of the generative model are updated by subtracting the reward value from a standard cross-entropy loss [symbol] ₜₒₜₐₗ= [symbol] _{CE}−βr, where [symbol] _{CE} is the standard cross-entropy loss, and β scales an impact of the reward value.

18. The computerized method of claim 11, further comprising:
analyzing entries of the long-term memory;
identifying patterns within the entries of the long-term memory;
generating insights based on the identified patterns; and
storing the generated insights within the long-term memory.

19. The computerized method of claim 11, further comprising:
analyzing entries of the long-term memory;
comparing a given pair of entries in the long-term memory to identify ambiguous, contradictory, or inconsistent statements;
responsive to determining that the given pair of entries contains ambiguous, contradictory, or inconsistent statements, generating a content flag;
storing the content flag within the long-term memory.

20. A computing system comprising:
processing circuitry and associated memory configured to implement:
an interaction interface configured to receive a message having natural language input;
a memory system comprising:
short-term memory,
working memory, and
long-term memory, wherein
the processing circuitry is configured to:
append the message to the short-term memory;
aggregate the short-term memory into the working memory; and
store the working memory into the long-term memory based on predetermined criteria;
retrieve one or more relevant entries of the long-term memory;
generate a contextual bundle including the one or more relevant entries of the long-term memory;
input the contextual bundle into a generative model to generate a response; and
output the response.
